(19) United States
(12) Patent Application Publication
(10) Pub. No.: US 2008/0208769 A1
(43) Pub. Date: Aug. 28, 2008

(54) CREATION AND MAINTENANCE OF A LIQUID "ALTERNATIVE BETA" INVESTMENT FUND

(76) Inventors: Andrew D. Beer, Fairfield, CT (US); Jerome Abernathy, Hoboken, NJ (US)

Correspondence Address: WINSTON & STRAWN LLP;PATENT DEPARTMENT, 1700 K STREET, N.W., WASHINGTON, DC, 20006, US

(21) Appl. No.: 12/036,857

(22) Filed: Feb. 25, 2008

Related U.S. Application Data
(60) Provisional application No. 60/891,594, filed on Feb. 26, 2007.

(51) Int. Cl. G06Q 40/00

(52) U.S. Cl. 705/36 R

(57) ABSTRACT

A method of creating and managing one or more investment funds that seek to match or exceed the investment performance of a distinct subset (the “alternative beta”) of the return stream provided by the hedge fund industry by replicating it through a dynamically-managed portfolio of liquid financial instruments. The method includes (a) analyzing the return stream using a combination of linear and nonlinear mathematical models; (b) identifying the specific components of the returns that can be replicated with liquid instruments; (c) selecting the financial instruments that meet certain criteria for liquidity, transaction costs and tax efficiency; (d) forming one or more investment funds that offer investors the ability to participate in such returns with superior liquidity and transparency; (e) directing the fund(s) to acquire the financial instruments in such manner as determined by the model; (f) rebalancing the portfolio on a regular basis to account for shifts in the investment patterns of the return stream. Software to perform the method using factors to minimize error inherent in regression analysis.

This application claims the benefit of provisional application No. 60/891,594 filed Feb. 26, 2007.

### BACKGROUND

The present invention relates to a method for creating and maintaining a liquid investment fund that seeks to match or exceed the investment performance of the “alternative beta” return stream provided by the industry of hedge funds as a whole by replicating such a return stream through a dynamically-managed portfolio of liquid financial instruments. “Alternative beta,” as discussed further herein, is defined as the subset of the return stream of the overall hedge fund industry that is attributable to bearing market risk premia.

### Alternative Investments as an Asset Class

Perhaps the most important development in the investment field over the past sixty years was the introduction of “modern portfolio theory” by Nobel Prize winner Harry Markowitz in a ground-breaking 1952 paper (Markowitz, 1952). Detailing a mathematics of diversification, Markowitz proposed that investors should focus on selecting portfolios based on their overall risk-reward characteristics instead of merely compiling portfolios from securities that each individually has attractive risk-reward characteristics. This paper prompted investors, academics and market participants to focus, for the first time, on not just the expected return of a given investment, but also how it is likely to behave relative to other potential investments. Specifically, Markowitz asserted that investors could optimize their portfolios to achieve a maximum amount of return for a given level of risk by changing the balance between different potential investments; this maximum return relative to a particular level of risk was defined as the “efficient frontier.”

Markowitz's paper, in a sense, launched six decades of financial innovation and research on the relationship between risk and return. Specifically, investors have come to appreciate that they can raise the efficient frontier (i.e. get more return for the same level of risk) by introducing potential investments with favorable risk-reward characteristics that are noncorrrelated to other potential investments. Over time, investment banks and investment firms have sought to offer a broader and broader array of potential investments in order to give investors as many options as possible in constructing their own efficient frontier. One can trace the development of the many of the innovations in financial products to this desire to identify attractive non-correlated investments.

Twelve years after Markowitz's paper, William Sharpe (who shared the Nobel Prize with Markowitz and Merton Miller in 1990) published his seminal paper “Capital Assets: A Theory of Market Equilibrium under Conditions of Risk” (Sharpe, 1964). Among other innovations, this paper effectively introduced the notions of “beta” and “alpha.” Since then, beta has come to be defined as the correlation between a given investment and the “market,” while alpha has come to be defined as the excess return of an investment that is not attributable to market movements. To simplify, if a given investment (say, a mutual fund) went up and down precisely as did the market as a whole (say, the S&P 500 index), then the fund would have a beta of 1 and zero alpha. Over the years, the definition of “beta” has been expanded to include any market risk (i.e. bonds, currencies, commodities, real estate), and alpha is generally considered to be returns that cannot be achieved through any one of these market exposures.

As a result, sophisticated investors today look to create investment portfolios that optimize returns for a given level of risk, drawing from a very, very broad pool of potential investments with differing risk-reward characteristics and a range of correlations to each other. Some of those “asset classes” (i.e. the stock market, bond markets, etc.) can be accessed in an efficient and low cost manner (i.e. index funds, ETFs), while others are more difficult to access. This latter category is often referred to as “alternative investments” and includes private equity funds, venture capital funds, real estate opportunity funds, oil and gas partnerships and hedge funds, among others. These investments are now considered attractive for two reasons: they provide potential investors with exposures that they typically are unable to obtain through traditional investments, and investors often expect to realize additional returns from the skills and investment acumen of the investment professionals who run them. The downside of such investments is that they typically are much less liquid than traditional investments and command much higher fees.

### The Hedge Fund Industry

The hedge fund industry did not start out as an “asset class.” A hedge fund, broadly defined, is merely an investment partnership or investment entity that seeks to generate returns for its investors by following one or more proscribed investment strategies. Unlike traditional investment managers, hedge fund managers are expected to (a) employ investment strategies that cannot be easily and efficiently replicated elsewhere and (b) have sufficient talent to generate returns in excess of their cost of capital (alpha). What differentiates a hedge fund from, say, a mutual fund is that the manager typically is entitled to receive a substantial portion of the profits (often, 20% or more) of the strategy in addition to customary management fees. In contract to mutual funds, hedge funds typically have much more stringent liquidity terms (quarterly or annual withdrawal periods) and provide limited information on the underlying investments.

Fifteen years ago, investors originally were attracted to the hedge funds because the managers were viewed as highly-talented investors who could generate high returns for investors by pursuing unique investment opportunities. In 1992, during the European Rate Mechanism crisis, many hedge fund managers, notably George Soros, were lauded (or chastised) for having made immense profits when England withdrew and the British Pound collapsed. The hedge fund industry was highly secretive, managers typically were expected to seek compelling investments across asset classes and geographic regions, and most investors were high net worth investors or family offices.

Since then, however, the hedge fund industry has grown by at least tenfold and changed dramatically. According to one industry consultant, there are now over 10,500 hedge funds that manage in excess of $1.4 trillion. There are hundreds of hedge funds dedicated to each specific strategy (equity long-short, merger arbitrage, distressed investing, market neutral, emerging markets, etc.), and an estimated two thousand funds that invest solely in portfolios of other hedge funds (funds of hedge funds). Investment managers, seeing the wealth creation potential of running a successful hedge fund, have rushed to set up new funds, and asset growth has been fueled by an influx of institutional investors who, for the reasons described previously, are seeking “alternative investments” that are non-correlated to traditional investments. Several firms have built extensive databases to track the performance of individual funds, specific strategies, and the industry as a whole. Hundreds of consulting firms now offer advice to investors on how to invest in hedge funds.

This rapid growth has changed the hedge fund industry in several material respects. First, the number of funds means that, by definition, the talent pool of the industry is spread thin. Second, competition among hedge funds for good investment ideas is fierce, with the result that many hedge funds have little if any competitive advantage over their peers. Third, vastly more capital is chasing each investment opportunity, with the result that industry-wide returns have suffered. Fourth, the rise of hedge fund databases means that sophisticated investors have more tools at their disposal to benchmark or otherwise analyze the returns of a specific fund or industry sector. Finally, institutional investors, who have become the most important source of capital for the industry in recent years, are seeking greater transparency and liquidity from underlying managers.

Despite these trends, there has been little if no reduction in fees paid to hedge fund managers. (In fact, in recent years many sought-after managers have actually increased fees and placed additional restrictions on investor liquidity.) As industry-wide returns have decreased, the high fee levels of the industry have attracted scrutiny. For instance, if a hedge fund manager generates a 15% return in any given year, over one-third (or 5%) of that return is likely to be paid in management and incentive fees. If the investor is investing through a fund of hedge funds, which charges its own fees, 40% or more of the gross return is likely to be paid to the manager. By contrast, an institutional investor would expect to pay substantially less than 1% if such returns were generated by a traditional manager. While most investors would agree that they are willing to pay large fees to managers who have unique talents or difficult-to-replicate business models, there is a growing sense that they are overpaying for the average hedge fund manager.

This concern is grounded in a belief that, unlike beta, alpha is finite in nature. Beta represents the risk premium (or expected return) that an investor can expect to receive for holding a particular asset. For instance, an investor in the stock market is “paid” for bearing the risk of stock price volatility, and hence can expect to be compensated through positive returns over time (which is why the stock market always goes up over extended periods of time). By contrast, alpha occurs when one investor earns excess returns at the expense of other investors—when one investor outguesses another, when supply-demand imbalances are created through structural or regulatory barriers, etc. Someone wins, someone loses. It is, in the end, a zero sum activity, and that the total amount of “alpha” in the financial markets is limited. Therefore, a rapid increase in the number of hedge funds and capital chasing such opportunities will, by definition, reduce each participant's share of aggregate alpha. In addition to the return and fee issues, many hedge fund products remain notoriously user-unfriendly, with high minimum investments, illiquidity, opacity, and tax-inefficiency.

Illiquidity is perhaps the biggest issues for many potential investors. Despite the fact that most hedge funds invest in liquid financial instruments, virtually all hedge funds only permit capital withdrawals at specified intervals (quarterly or annual or longer), often with long notification periods (45 to 180 days). This makes it difficult for investors to withdraw from hedge funds at precisely the time when they are most likely to want to: when the fund is doing poorly. Unfortunately, many hedge funds have wide latitude to restrict withdrawals during such times of crisis. This illiquidity issue is a significant problem for many investors, particularly those institutions that have regulatory restrictions on their ability to hold illiquid securities.

There is another issue that deters many potential investors who otherwise might benefit from the hedge fund return stream. In recent years, there have been a number of well-publicized failures of hedge funds, which can be deeply embarrassing for the institutions and officials who invested with them. As a result, there continues to be a large pool of intuitional investors who, due to investment restrictions, are either reluctant to or precluded from investing in many strategies or manager.

### Funds of Hedge Funds

Due to the obstacles of investing directly in hedge funds, many investors have chosen to invest in funds of hedge funds. Funds of funds typically allocate capital among twenty or more hedge funds in order to provide diversification. These investment vehicles arose to overcome several of the barriers to hedge fund investing. For instance, while it often is difficult for investors to identify qualified hedge fund managers, the fund of funds manager is likely to have substantial expertise in identifying hedge funds, conducting due diligence on hedge funds, and monitoring their performance over time. In addition, smaller investors gain the benefit of diversification, which they otherwise would be unlikely to achieve given the high investment minimums in individual funds. Fund of hedge funds sometimes are able to invest with managers who are closed to other investors. One industry observer now estimates that over half the capital invested in hedge funds is actually invested through funds of funds.

However, funds of hedge funds have several significant structural problems. Perhaps most importantly, fund of funds charge fees (and pay administrators, attorneys, etc.) in addition to those charged by the underlying hedge funds, and hence compound, rather than alleviate, the fee problem. As industry returns have declined over the past decade, this additional layer of fees has become a more significant percentage of returns. For instance, over the past three years, fund of funds fees are estimated to have exceeded 10% of the returns provided by the underlying managers.

Further, since funds of funds themselves invest in the underlying funds, they often require investors to abide by the same or similarly stringent liquidity provisions. Therefore, while they may provide diversification, they do not address the fundamental liquidity problems in the industry as a whole.

Funds of hedge funds have two other structural problems: “performance netting” and “negative tax arbitrage.” Performance netting refers to the drag on returns attributable to the asymetric fee structure of the underlying hedge funds: the fund of funds effectively only receives 80% of the profits to the underlying managers (due to the performance fee), but bears 100% of the losses. As a result, if half the funds increase by 20% (i.e. 16% after performance fees) and half decline by 20%, the fund of funds would actually lose 4% rather than break even (this analysis ignores management fees, which tends to exacerbate the problem).

Fund of funds can also be very tax-inefficient investments. Under the current US tax regime, short-term trading (short-term capital gains) is taxed at a higher rate than long-term investments (long-term capital gains). Since hedge funds tend to trade actively, the vast majority of performance returns tends to be taxed at the higher marginal rate. In certain circumstances, funds of hedge funds are subject to “negative tax arbitrage”: that is, a higher effective tax rate than the actual statutory maximum tax rate. Similar to performance netting, this occurs when the character of the income (i.e. short term capital gains or ordinary income) cannot be offset under US tax law by the character of the losses (i.e. long-term capital losses). For example, if half the underlying funds generate a 20% return (net of performance fee) in short term capital gains, and the other half lose 10% in long-term capital losses, the effective tax rate for a taxable US investor is likely to be around 70% ([35% effective tax rate*20% return on winning funds]/10% return on portfolio).

### Other Hedge Fund Investment Products

A more recent development is the advent of “investable” hedge fund indices. Investable indices were introduced several years ago by the firms that maintain hedge fund indices in order to provide investors with a means of investing directly in the industry as a whole, rather than through funds of funds. The firms were, in a sense, trying to replicate the success of the S&P 500 Index and other investable indices, which enable investors to efficiently increase or decrease broad equity market exposure. However, in addition to the structural problems of funds of hedge funds cited above, investable hedge fund indices have several distinct problems. Unlike the S&P 500, which has very liquid underlying instruments (large capitalization stocks), the investable hedge fund indices have been hampered by the restrictive nature of hedge fund investing in general. For instance, in order to be able to offer transparency and liquidity, the indices are only permitted to invest with managers who will create separately managed accounts and provide full transparency on the underlying portfolio. However, superior managers are unlikely to offer the transparency required out of fear of revealing proprietary information, and typically have no need for the additional capital, particularly on such unfavorable returns. As a result, the investable indices tend to invest with inferior managers, who are more likely to accede to such terms. The unfortunate consequence of this is that the “investable” versions of indices have underperformed their “noninvestable” counterparts by approximately 500 basis points on average over the last several years. Further, the investable hedge fund indices do not reduce industry-wide fees nor, in most cases, provided any incremental liquidity benefits.

Some investors have even sought to create funds of funds of hedge funds (“F3s”) in an effort to achieve broad industry exposure. These products further exacerbate the cost issue by layering in yet another level of management fees, and do not resolve the underlying liquidity issue since the F3 is ultimately subject to the liquidity terms of the funds of hedge funds in which it invests, who in turn are subject to the liquidity terms of the underlying hedge funds. In addition, these funds do not resolve the dual issues of performance netting and negative tax arbitrage.

U.S. Pat. No. 7,085,738 discloses an investable index of funds of hedge funds. This product is akin to a highly diversified F3 in which the selection of funds of hedge funds in conducted in a proprietary manner. However, like F3s, the product is indirectly invested in the underlying hedge funds, compounds the fee problem, does not seem to provide a liquidity solution, and fails to address the dual issues of performance netting and negative tax arbitrage. Despite this patent, there remains a need for investment vehicles that provide the higher returns achievable by hedge funds while remaining liquid for the investor.

### Analyses of Hedge Fund Industry Returns

As the industry has grown, various academics and industry observers have sought to understand the source and nature of hedge fund returns. The proliferation of hedge fund databases, some of which actively track over 6,000 funds, provides a wealth of data to researchers. Much of this data now goes back to over ten years. Relative to ten, or even five years, ago, researchers have substantially more information with which to analyze the return stream of the industry.

This analysis, to date, has followed two disparate paths. In the first instance, many industry participants, such as consultants and institutional investors, have sought to analyze the returns of the industry “as a whole.” This analysis has sought to verify that the hedge fund industry generates sufficiently high returns over time to merit inclusion in diversified portfolios. A key component of this analysis is understanding the extent to which hedge fund returns are non-correlated to those of other asset classes, such as equities and bonds. As shown previously, this non-correlation becomes important in constructing a portfolio's efficient frontier. Most frequently, this analysis has been conducted using one or more of the published industry indices and, hence, are subject to all of the limitations and biases of the underlying data. Importantly, one of the key assumptions of such analysis has been that the returns of the industry, as a whole, are linear in nature.

The other type of analysis is more recent and theoretical. Typically conducted by academics, these studies seek to discern the source and nature of the returns of funds themselves. Significantly, this research has demonstrated that the return characteristics of some (but not all) strategies are non-linear in nature—that is, outlier return data are more exponential in nature than linear. For instance, Weissman and Abernathy (1998) showed that certain bond trading strategies evidenced a similar risk-return profile to writing certain options on fixed income instruments. Fung and Hsieh (2001) demonstrated that macro and trend-following strategies evidence similar return characteristics to an esoteric form of option called a “lookback option.” Mitchell and Pulvino (2001) compared the returns of merger arbitrage funds to selling put options on equity indices. Importantly, all three of these studies conclude that the return profile of certain hedge fund strategies—fixed income arbitrage, macro/trend-following and merger arbitrage—are likely to generate positive returns in most periods, but will occasionally suffer significant losses. The drawback of such studies is that they fail to provide a means to efficiently replicate the returns of the individual strategies.

For practitioners in the industry, these results support the notion that hedge fund returns, while presenting as linear in times of stability, often become “non-linear” at key moments of convergence or instability in the financial markets.

Several academics have also sought to determine the extent to which hedge fund returns for the industry as a whole are derived from unique investment strategies and manager talent (alpha) versus merely assuming market risk (beta). In this context, it is important to note that the definition of “market” risk or returns is now broader and more complicated than it used to be. For instance, with financial innovation, market returns can include the risk premia associated with credit spreads, relative interest rates, yield curves, small capitalization versus large capitalization stocks, among others. Therefore, while it is possible to identify these risk “factors,” most investors are still unlikely to access them directly since doing so requires them to buy and sell sophisticated financial derivatives. Cliff Asness, a founder of one of the largest hedge fund groups, has coined these other risk factors “alternative beta”—beta, but sufficiently difficult to access that it should be considered part of the alternative investment universe (Asness 2004). In fact, many of these financial products were either insufficiently liquid or otherwise unavailable as recently as five years ago, so many elements of this alternative beta indeed are still emerging.

In order to isolate the returns that can otherwise be replicated (i.e. this “alternative beta”), Hasanhodzic and Lo (2006) conducted a linear multi-factor model to determine the extent to which the returns of numerous individual hedge fund strategies could be explained by beta factors. In it, they concluded that a significant portion of the returns for certain strategies could be explained by the simple linear factors. However, the study by Hasahodzic and Lo suffers from several significant methodological problems. The database of fund returns includes only those funds still “live” in late 2005 and extends back to 1986; even though there were very few hedge funds in existence twenty years ago, and even fewer that reported information to databases or that are still in existence (in fact, the database from which the data is drawn was not even created until almost a decade after the inception of the data, which renders it highly subject to both survivorship and backfill biases). As a result, the earlier data points in this study are limited and will by definition distort the outcome of the study. There further is no effort to account for funds that have failed or no longer report to the databases; by contrast, the reliance on fund of funds indices in the present invention better accounts for both factors, since funds of funds returns incorporate the returns of funds that have failed and those that do not report to indices.

In addition, the Hasanhodzic and Lo study incorporates only linear factors, despite the growing pool of evidence that nonlinear factors are more representative of hedge fund return streams. Two of the factors chosen are either insufficiently liquid (AA corporate bonds) or unavailable in an easily-tradable form (volatility); therefore, unlike the present invention, the study does not offer a practical alternative for investors. Finally, the study assumes a constant pool of factors over time, which fails to account for the dynamic manner in which funds have adopted their trading methodologies and use of financial instruments over the past two decades.

Supporting this result, Jaeger (2005) concludes that up to 80% of hedge fund industry returns are attributable to beta factors, not alpha. Rather than analyzing the industry as a whole, Jaeger seeks to replicate individual hedge fund strategies, and aggregate them into a proxy for the industry returns.

While Jaeger correctly identifies that nonlinear factors are a critical underpinning of hedge fund returns, there are several significant limitations to Jaeger's approach. First, Jaeger exclusively analyzes the returns of individual hedge fund strategies rather than those of the industry as a whole; this renders his analysis subject to the arbitrary classifications applied to the underlying funds, when in reality most funds employ a combination of strategies and shift focus over time. Second, Jaeger relies on indices of hedge funds for the underlying strategies, which he admits are subject to significant survivorship and backfill biases; the present invention employs indices of funds of funds in order to minimize such biases. Third, Jaeger introduces an artificial auto-regression factor to explain a substantial portion of the returns of some of the strategies; this factor is a theoretical factor that cannot be replicated with financial instruments and therefore is irrelevant for purposes of constructing a portfolio. Fourth, Jaeger confines his analysis to a limited number of factors (typically, three or four) and assumes that the factors cannot change over time; the present invention provides the flexibility for more factors and for those factors to change over time. Finally, Jaeger acknowledges that his use of linear modelling fails to account for the nonlinear characteristics of market breaks; the present invention is specifically designed to address such scenarios.

There is other evidence that supports this trend. Many market observers have noted that, in recent years, hedge funds that in theory are heterogeneous have performed similarly (i.e. become highly correlated) particularly during times of market distress. This has led some market observers to conclude that hedge funds increasingly hold overlapping or similar positions, which is indicative of the increasing importance of some form of “market” risk or risks.

The implication of this analysis is striking: it suggests that investors are overpaying for a large percentage of the returns generated by the hedge fund industry, since those returns are derived from market risk premia rather than manager talent or unique investment strategies. (It is important to note that, even if hedge fund industry returns are increasingly driven by these esoteric market risk factors, the hedge fund return stream is still very valuable in portfolio construction. The question for investors is whether the aggregate fees, illiquidity and user-unfriendly nature of hedge funds are warranted if a majority of the return stream can be replicated elsewhere.)

Existing studies have failed to provide an effective methodology for estimating and replicating the market-based returns of the hedge fund industry. There are several reasons for this. First, by focusing on individual strategies, many of the studies are too narrow in scope and do not provide a return estimate for the industry as a whole. Typically, the number of funds in each particular strategy is limited; further, as with many hedge funds, such funds are likely to pursue a range of strategies or to shift strategies over time, which limits the predictive power of the results. The current invention seeks instead to isolate the alternative beta returns of the industry as a whole by analyzing the historical returns of funds of hedge funds, which provide a more accurate proxy for actual industry returns and are less subject to the biases inherent in indices of hedge funds themselves.

Second, by utilizing data on individual managers in the hedge fund databases, the results are subject to the same biases as the database as a whole. This is particularly true of strategies that have non-linear return characteristics. For instance, with periodic episodes of market turbulence, the non-linear nature of these returns means that more funds in this space will go out of business. This, by definition, will limit the data pool to those funds that manage to survive—which can distort results upward and provide false confidence on fund survival rates. Importantly, even though the databases may classify a particular fund according to a specific strategy, the reality is that funds tend to shift strategies over time as market conditions change. By definition, this will distort the results. The current invention addresses this by relying to returns of funds of funds, rather than those of the underlying managers, since funds of funds returns are an effective proxy for industry returns and, since the returns reflect actual performance, mitigate the impact of these other biases.

Third, the failure to incorporate non-linear factors distorts the results and increases the magnitude of the error, particularly during times of market dislocation. (Recently, Merrill Lynch introduced an institutional equity derivatives product, the Merrill Lynch Factor Index, that utilizes only linear factors.) Non-linear factors, while more esoteric and complex, are critical factors in how hedge funds perform over time. Importantly, many distinct funds with differing strategies may assume the same risk factors over time, which can exacerbate losses during market dislocations. Importantly, by analyzing the returns of funds of funds, the present invention effectively captures the impact of non-linear returns since the returns reflect actual performance.

Fourth, the studies fail to provide an effective and efficient means of replicating such returns—i.e. the fund format described herein. While in theory a large institution might have the resources and knowledge to construct a portfolio of complex financial derivatives, the reality is that few investors have the capacity or willingness to enter into such position themselves. There are numerous structural reasons, as described further below, why a liquid fund format resolves many of the hurdles inherent in hedge fund investing.

Accordingly, there is a need for improved hedge funds that rely upon better models as well as to provide greater safety and tradability for the investor. These are now provided by the present invention.

### SUMMARY OF THE INVENTION

In accordance with one embodiment, the invention provides a method and system of creating and managing an investment fund that replicates the investment performance of a defined subset (the “alternative beta”) of the return stream provided by a hedge fund index. The method comprises providing historical returns of various financial instruments and the hedge fund index; screening financial instruments based on predetermined criteria; and establishing optimization parameters to help evaluate investment performance. The method further includes performing an optimization analysis utilizing the historical returns of the screened financial instruments, the historical returns of the hedge fund index, and the optimization parameters so as to identify a portfolio of substantially liquid investments that replicates the investment performance of the defined subset of the return stream provided by the hedge fund index; and creating an investment fund to acquire the investments of the portfolio, whereas the fund is substantially liquid.

Preferably, the optimization analysis is based on linear and nonlinear mathematical models. Optimization parameters utilized in the optimization analysis may include return, risk, volatility, and correlation. Generally, the defined subset of a return stream is the “alternative beta” portion of the return stream.

In the preferred embodiment, the predetermined criteria for screening the financial instruments include the liquidity of the financial instruments. Predetermined criteria may also include transaction costs and market size. Due to the liquidity of the fund, the method may further comprise allowing periodic withdrawals to investors upon request. Advantageously, such a request for withdrawal can be made on monthly, weekly or daily basis.

Historical return of the hedge fund index generally suffers from biases arising from the limitation of the data collection method. In one embodiment, the historical return of the hedge fund index is adjusted for biases prior to performing of the optimization analysis. Whilst in another embodiment, the optimization analysis includes compensation for the inherent biases in the historical return of the hedge fund index. These biases may include survivorship bias and backfill bias.

Preferably, the hedge fund index is the HFR hedge fund index, the CSFB Tremont hedge fund index, the HFR fund of hedge fund index, or another similar index. Hedge fund indices are typically updated periodically, and as a way of maintaining the portfolio current with the latest hedge fund index, the method may further comprise updating the portfolio on a regular basis.

In general, the fund may be structured as a US limited partnership, an offshore corporation, a mutual fund, or as a registered investment company. According to one aspect of the invention, the method further comprises structuring the fund to limit portfolio losses on a monthly or weekly basis. The fund may enter into stop-loss positions that limit losses on any given financial instrument to a stipulated amount. Further, the fund may buy options to provide downside protection for the portfolio as a whole.

The invention also comprises a computer operating system that performs the steps of the method described above. The computer operating system comprises a database and a processing unit in communication with the database.

As discussed more fully herein, the present invention is specifically designed to address the structural issues with hedge fund investments that were previously described. Because such hedge funds are either directly or indirectly are invested in hedge funds, funds of funds, F3s and other fund products are subject to the high fees, illiquidity, opacity, tax inefficiency and other issues of the underlying investments. The present invention solves these issues by investing in a liquid portfolio of financial derivatives that replicates the returns of the industry, rather than investing in the funds themselves.

The invention thus comprises the steps of (a) analyzing the return stream of one or more hedge fund indices using a combination of linear and nonlinear mathematical models; (b) identifying the specific components of the returns that can be replicated with liquid instruments; (c) selecting the financial instruments that meet certain criteria for liquidity, transaction costs and, in some cases, tax efficiency; (d) forming one or more investments funds that offer investors the ability to participate in such returns with superior liquidity and transparency; (e) directing the fund or funds to acquire the financial instruments in such manner as determined by the model; (f) rebalancing the portfolio on a regular basis to account for shifts in the investment patterns of the return stream.

The invention also comprises software to perform the steps of the method described above, in particular the proprietary analysis of various hedge fund indices using linear and nonlinear factors in a manner that accounts for the characteristics of the relevant target series and minimizes the mean inherent in regression analysis.

### BRIEF DESCRIPTION OF THE DRAWING FIGURES

FIG. 1 is a flow diagram that illustrates the general structure of a Fund created and maintained according to the present invention.

FIG. 2 is a flow diagram that outlines a preferred embodiment of the invention for constructing a portfolio to replicate the “alternative beta” return stream of the hedge fund industry.

### DETAILED DESCRIPTION OF THE PREFERRED EMBODIMENTS

The present invention is designed to address the market need for a liquid, low cost fund product that effectively replicates the return stream of the hedge fund industry. The fund product is able to achieve this by determining the market risk factors that account for the majority of hedge fund returns, and reconstructing those risk factors using liquid financial derivatives. By eliminating the high fees (and multiple layers of fees) endemic to hedge fund investments, the present invention offers investors the ability to outperform the hedge fund industry over time; by reconstructing the majority of hedge fund returns without actually investing in hedge funds, the fund is able to offer materially better investment terms to investors.

Specifically, the invention is designed to offer a superior risk-reward profile with vastly-more user-friendly terms than a typical fund of hedge funds (or F3, or investable index). Due to the fees and restrictions inherent in hedge fund investing, there is no fund product based on actual investments in hedge funds (whether directly or indirectly) that can effectively offer the return profile and terms provided by the current invention; therefore, the key innovation is dual-fold: the capacity to effectively replicate the alternative beta component of hedge fund returns, and providing such return in a fund product that addresses the limitations of existing products.

Generically, there are numerous benefits of investing in a fund, rather than directly. First, a fund enables numerous investors to co-mingle their investments, and thus provide economies of scale to reduce trading costs, management fees and administrative costs. A fund format enables the manager to standardize reporting to investors and to generate an actual performance track record. Funds provide liability protection to investors, such that their risk is limited to the amount invested, and the fund, rather than the investor, is the party that enters into various market agreements. In addition to the “hedge fund” format, which is familiar to investors, the present invention is intended to work in a mutual fund format and other investment vehicles.

The key characteristics of the fund product are as follows:
Low management fees: the fund(s) will charge a flat management fee and no incentive fee, thus providing investors with superior net returns over time.
Liquidity: unlike typical hedge funds, the product will be highly liquid. Liquidity will range from daily to monthly, consistent with the liquidity of the underlying instruments.
Transparency: unlike typical hedge funds, investors will be given full transparency to the positions in the fund's portfolio.
Tax efficiency: Most hedge funds and funds of funds are notoriously tax inefficient. The fund and subsequent products are expected to have lower effective tax rates than the hedge fund industry as a whole, and thus superior after-tax returns. Importantly, the fund eliminates the issue of negative tax arbitrage for taxable investors.
No manager risk: Unlike an investment in a hedge fund or fund of funds, there are no active managers in the portfolio, and hence no risk that one of the underlying managers has a highly-publicized failure. This is valuable for pension funds and other institutions that tend to be sensitive to “headline” risk.
Dynamic downside protection: A variant of the fund will utilize risk management techniques to limit the value-at-risk or monthly drawdowns to a specified amount. An investor in a typical hedge fund or fund of funds, due to the illiquidity and lack of control, is precluded from such protections.

### Methodology

The method of determining the portfolio composition is as follows. A database of historical returns of the hedge fund industry as a whole is initially compiled. These data include monthly returns that date as far back as to the late 1990s and are downloaded from private database fund services. The return stream is then analyzed by comparing its movements on a monthly basis to those of eight to ten financial derivatives (or factors). These factors include the return on futures on the S&P 500 stock index, global stock indices, various commodities, interest rates, volatility, yield curves, and options, among others. On a rolling basis, the computer model determines the weighting of the underlying factors in a manner that best approximates the return and volatility profile of the hedge fund return stream over the preceding periods.

For example, at the Fund's inception, computer models can determine what the Fund's portfolio should consist of a specified percentage weighting of each factor in order to maximize returns relative to risk while approximating the return profile of the hedge fund industry as a whole. The various derivatives are then bought (or sold) in order to construct a portfolio that matches the one specified in the model. Historically, following such a methodology would enable the Fund to substantially outperform the hedge fund industry as a whole with no incremental risk, greater liquidity, etc. etc.

### Fund Structure and Outline of Process

In the preferred embodiment, the Fund of the present invention can be structured as an investment partnership, mutual fund, regulated investment company, offshore investment company, among many other configurations. As with any fund, Investors have the opportunity to contribute and withdraw capital on a periodic basis, the capital is invested in a defined strategy, the fund administrator calculates a net asset value (NAV), and accrued fees and expenses are deducted from the asset value.

Unlike a hedge fund, however, the Fund (a) will charge a flat management fee and no incentive fee, thus providing investors with superior net returns over time; (b) the product will be highly liquid, ranging from daily to monthly, consistent with the liquidity of the underlying instruments; and (c) investors will be given full transparency to the positions in the fund's portfolio. A variant of the Fund will utilize risk management techniques to limit the value-at-risk or monthly drawdowns to a specified amount. An investor in a typical hedge fund or fund of funds, due to the illiquidity and lack of control, is precluded from such protections. Most hedge funds and funds of funds are notoriously tax inefficient. The Fund is expected to have lower effective tax rates than the hedge fund industry as a whole, and thus superior after-tax returns. Finally, unlike an investment in a hedge fund or fund of funds, there are no active managers in the portfolio, and hence no risk that one of the underlying managers has a highly-publicized failure. This is valuable for pension funds and other institutions that tend to be sensitive to “headline” risk.

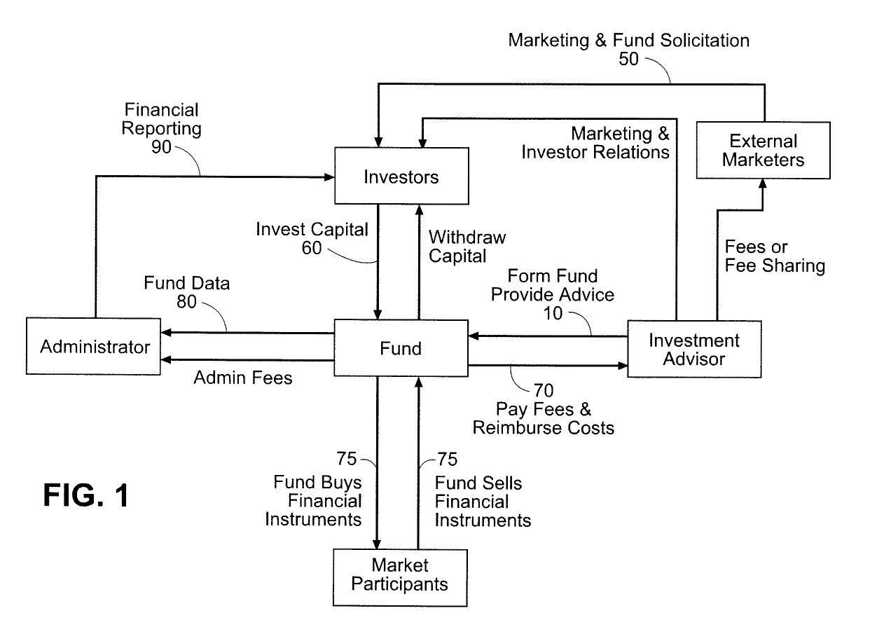

FIG. 1 shows the general structure of the fund according to present invention. In Step 10, an investment fund (“Fund”) is formed, typically by the Investment Advisor. The formation of the Fund entails, among other things, the selection and retention of attorneys to form and advise the Fund entities, selection and retention of accountants to audit the financial performance of the Fund, selection and retention of an Administrator to provide financial reporting to Investors (in certain cases, this function is provided by the Investment Advisor or Fund itself), entering into legal arrangements with various market participants (including, but not limited to, prime brokers and futures commission merchants), and preparation of Fund legal documents (including, but not limited to, disclosure statements for Investors and investment advisory agreement with Investment Advisor).

In Step 50, the Investment Advisor seeks to identify Investors for the Fund. In one embodiment, the Investment Advisor directly solicits potential Investors; in another embodiment, the Investment Advisor retains External Marketers to identify and solicit potential Investors in return for either a fee agreement or fee sharing agreement.

In Step 60, Investors invest capital in the Fund. Typically, the investment in Fund will be coordinated by either Investment Advisor or External Marketer, or both. Investors typically provide subscription and withdrawal information to the Investment Advisor, who provides such to the Administrator in order to maintain accurate records on increases and decreases in Investor capital and specific Investor capital balances. Once an investor decides to invest in the Fund, he wires funds to the Administrator, which directs the funds to the Funds account. The investor receives shares or a partnership interest in the Fund, the amount of which is preferably calculated by the following formula: Shares/Interest=(Wire Amount-Transfer Costs)/(NAV of the Fund).

During the life of the Fund, at stipulated investment and withdrawal periods (daily to monthly), it is expected that new Investors will invest and existing Investors either maintain their existing investments, add to their investments, or withdraw all or a portion of their investments. As a result, the composition of the Investors may change over time. The Fund provides information on net increases and decreases in capital from additional investments and withdrawals to the Administrator. Unless otherwise determined, Withdrawal Amount NAV*Shares[or Interest]−Costs of Transfer.
In Step 70, the Investment Advisor provides advice to the Fund on how to allocate the capital of the Fund according to the investment strategy, and the Fund pays investment advisory fees to the Investment Advisor. According to this advice, the Investment Advisor directs the Fund to buy and sell various financial instruments (Step 75) with one or more Market Participants in order to construct the desired portfolio. As financial instruments are bought and sold, the Fund provides trading records to the Administrator (Step 80). Depending on the investment objectives of the particular Fund, the investment advice can provides as irregularly as once per month, and as frequently as many times per minute.

In Step 90, the Administrator (or, in some instances, either the Fund itself or the Investment Advisor) uses the information on capital balances, trade data, costs and investment advisory fees to calculate the returns to investors over the specified accounting period. The Administrator increases and decreases the capital accounts of the existing Investors as a result of the net returns. This information is regularly provided by the Administrator to Investors (or, alternatively, is provided to the Investment Advisor, who furnishes such information to Investors).

Typically, if the Investment Advisor is actively seeking new Investors, then Steps 10 through 90 will be repeated on a regular basis. Importantly, in the preferred embodiment, the Investment Advisor will provide investment advice on a regular basis and rebalance the portfolio accordingly.

### Constructing the Optimal Portfolio for the Fund

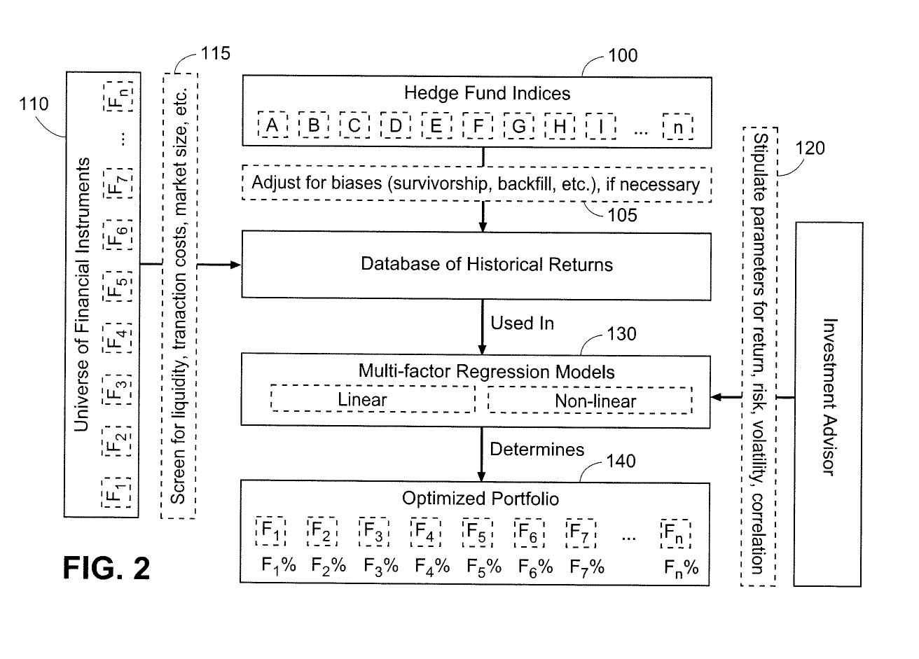

FIG. 2 outlines the preferred embodiment of constructing a portfolio to replicate the “alternative beta” return stream of the hedge fund industry.

In Step 100, historical return information is collected on a number of hedge fund indices, including the HFR Hedge Fund Index, CSFB Tremont Hedge Fund Index, HFR Fund of Funds Index, HFRX Investable Index, among others. In FIG. 2, these indices are represented by the letters A, B, C, etc. This information is either downloaded directly from the provider of the index, or through independent data providers. In Step 105, the Investment Advisor may adjust the index data in order to account for various biases, especially survivorship and backfill bias. Alternatively, the Investment Advisor may incorporate such adjustments directly into design of the multi-factor models, as outlined below.

In Step 110, historical return information is collected on a broad range of financial instruments that are determined by the Investment Advisor to be candidates for inclusion in the multi-factor models. In FIG. 2, these financial instruments are represented as F1, F2, F3, etc. This information typically is available through independent data providers. The candidate financial instruments are screened according to several characteristics (Step 115). First, financial instruments that have insufficient trading volume are rejected. Next, those with unusually high trading costs are rejected. Third, those with insufficiently large trading markets are rejected. Depending on the structure of the Fund, certain financial instruments will be rejected if there are regulatory or other reasons why the Fund would be precluded from buying and selling them. The remaining set of candidate financial instruments is included in the database of historical return information.

In Step 120, the Investment Advisor stipulates parameters for expected return, risk, volatility, correlation, and tracking error, among other factors. These parameters are selected according to the investment objectives of the specific Fund. For instance, certain Funds will provide investors with higher expected returns, but at the expense of greater risk and perhaps greater tracking error; other Funds might be designed to minimize tracking error to a specific index, even if such minimization occurs at the expense of overall returns (in this instance, the Investment Advisor would also specify that they multi-factor models analyze only the historical returns of the specified index).

In Step 130, the Investment Advisor runs linear and non-linear regression models that are specifically designed to identify the “factors”—i.e. financial instruments—the can replicate the “alternative beta” portion of the hedge fund return stream. These models include static sliding windows, dynamic window periods determined using Kalman filters, step-wise regressions, among other modelling techniques.

In Step 140, the multi-factor regression models determine an optimized portfolio based on the parameters provided. As shown in FIG. 2, the portfolio is represented as a series of financial instruments (F1, F2, etc.), each of which constitutes a certain percentage (F1%, F2%, etc.) of the portfolio or investment capital. As outlined previously in Steps 70 and 75, the Investment Advisor uses this information to advise the Fund on which financial instruments to buy and sell in order to construct or rebalance its portfolio to meet the proscribed weightings.

The frequency of repeating Steps 100-140 depends on the frequency of updates in the underlying data, especially the hedge fund indices. For instance, if a Fund is seeking to replicate the return stream of an index that only reports data monthly, then the analysis and portfolio construction is likely to occur monthly as well. On the other hand, if the analysis incorporates data from indices that report daily (such as some of the “investable” indices), then analysis and portfolio rebalancing may occur more frequently.

What is claimed is:

1. A method of creating and managing an investment fund that replicates the investment performance of a defined subset of a return stream provided by a hedge fund index, which comprises:
providing historical returns of various financial instruments and the hedge fund index;
screening financial instruments based on predetermined criteria;
establishing optimization parameters to help evaluate investment performance;
performing an optimization analysis utilizing the historical returns of the screened financial instruments, the historical returns of the hedge fund index, and the optimization parameters so as to identify a portfolio of substantially liquid investments that replicate investment performance of the defined subset of the return stream provided by the hedge fund index; and
creating an investment fund to acquire the investments of the portfolio, whereas the fund is substantially liquid.

2. The method of claim 1, wherein the optimization analysis is based on linear and nonlinear mathematical models.

3. The method of claim 1, which further comprises updating the portfolio on a regular basis.

4. The method of claim 1, wherein the predetermined criteria includes the liquidity of the investment.

5. The method of claim 4, wherein the optimization parameters comprise of return, risk, volatility, and correlation.

6. The method of claim 1, wherein the historical return of the hedge fund index is adjusted for biases.

7. The method of claim 6, wherein the biases comprises survivorship and backfill.

8. The method of claim 1, wherein the fund is structured as a US limited partnership, an offshore corporation, a mutual fund or as a registered investment company.

9. The method of claim 1, which further comprises allowing periodic withdrawals to investors upon request due to the liquidity of the portfolio.

10. The method of claim 9, wherein the request for withdrawal can be made on monthly, weekly or daily basis.

11. The method of claim 1, wherein the hedge fund index is one of a HFR hedge fund index, a CSFB Tremont hedge fund index, the HFR fund of hedge fund index, or another commonly-followed index.

12. The method of claim 1, wherein the optimization analysis includes compensation for inherent biases in the historical return of the hedge fund index.

13. The method of claim 1, which further comprises structuring the fund to limit portfolio losses on a monthly or weekly basis.

14. The method of claim 1, wherein the fund enters into stop-loss positions that limit losses on any given financial instrument to a stipulated amount.

15. The method of claim 1, wherein the fund buys options to provide downside protection for the portfolio as a whole.

16. The method of claim 1, wherein the defined subset of a return stream is alternative beta fraction of the return stream.

17. A computer operated system for creating and managing a fund replicating investment performance of a defined subset of a return stream provided by a hedge fund index, comprising:
a database for historical returns of various financial instruments and the hedge fund index;
a processing unit in communication with the database, the processing unit operative to:
screen financial instruments based on predetermined criteria;
receive optimization parameters;
perform an optimization analysis based on historical returns of the screened financial instruments, historical returns of the hedge fund index, and the optimization parameters, so as to identify a portfolio of substantially liquid investments that replicate investment performance of the defined subset of the return stream provided by the hedge fund index; and
create an investment fund to acquire the portfolio, whereas the fund is substantially liquid.
